(19) United States
(12) Patent Application Publication
(10) Pub. No.: US 2018/0108082 A1
(43) Pub. Date: Apr. 19, 2018

(54) SYSTEM AND METHOD FOR COUNTERBIDDING PROCESS IN AN ONLINE AUCTION

(71) Applicant: COPART, INC., DALALS, TX (US)

(72) Inventors: CHRISTOPHER HART, PLANO, TX (US); JOHN LINDLE, DALLAS, TX (US)

(21) Appl. No.: 15/297,287

(22) Filed: Oct. 19, 2016

(51) Int. Cl. G06Q 30/08

(52) U.S. Cl. CPC G06Q 30/08

(57) ABSTRACT

A method for conducting an online auction conducts, by an online auction system, the online auction to generate a final online auction bid. The online auction system determines whether to generate a counterbid offer responsive to first data relating to a seller and second data relating to a buyer providing the final online auction bid. The online auction system then completes the sale of the vehicle responsive to the determination to generate the counterbid offer.

### TECHNICAL FIELD

The present invention relates to online auctions, and more particularly, to an automated sale type selection counterbidding processes that do not require real time buyer/seller inputs.

### BACKGROUND

The Internet is the most widely recognizable global computer network in existence. The computers of the Internet are linked via a globally unique address space called Internet protocol (IP) addresses. Since its explosion in the early 1990s, the Internet has enhanced the prosperity of businesses related to everything from gaming to music to retail sales. In fact, as more and more people have gained access to the Internet and have learned to effectively navigate the Internet, Internet sales have continue to increase at an incredible rate. One extremely successful online business venture has been the advent of the online auction.

For their part, online auctions have reduced auctioneer fraud and collusion between a live auctioneer and live bidders. In addition, online auctions are limitless in their scope. Because of their ease-of-use, online auctions attract millions of sellers and buyers each and every day for the sole purpose of auctioning off and buying goods. Clearly, live auctions of such a scale are not realistic where bidders must be physically present.

Traditionally, live auctions utilize a format whereby items put up for bid are placed on an auction sale list. Thereafter, the listed items are auctioned consecutively at a preestablished date and time. When the live auction begins, one listed item at a time is auctioned off until no items remain. The auction on individual items ends when no further bids are submitted.

In contrast, typical online auctions allow for multiple items to be auctioned simultaneously. The start and finish time for the online auction items is independent from the other items being auctioned. Additionally, online auctions end at a preestablished time rather than when no further bids are submitted.

Even though the recognized auction websites are very successful, the current online auction format is slow, cumbersome and frequently inefficient in garnering a maximum sales price for the items being auctioned. By way of one example, typical online auctions allow sellers to auction items for a preestablished duration of time. When bidders go online to access and view a particular item of interest, they are provided a record of the time remaining until the auction ends. As people bid for a particular item, they can only hope that another bidder does not bid so close to the end of the auction that it is been impossible for the original bidder to place another bid. Of course, under the existing online auction formats such intentional late bidding is a frequent and planned occurrence. More ever, this online auction format does not encourage any true bidding “frenzy” until the last few minutes of the auction. Unfortunately for sellers, this online auction format does not always result in a bidding environment that allows the seller to maximize the sales price of their item up for auction. In other words, just as the bidding “frenzy” has started, the bidding is routinely terminated according to the preestablished time set for the auctions expiration.

Additionally, some types of online auction protocols require seller approval of finally receive bids for an item. The seller will either accept the offer or provide a further counteroffer in order to attempt to achieve an even higher price. This counterbidding process requires a significant amount of time as the auction price is considered by the seller. The seller determines whether or not to make a counter offer, and the buyer must consider and respond to the counteroffer. This can draw the auction process on for a significant additional period of time.

Therefore, there is a need for an online auction system that provides sellers with the opportunity to maximize returns without constant seller input, while retaining the inherent benefits for both sellers and buyers of conventional online auction systems.

### SUMMARY

The present invention, as disclosed and described herein, comprises in one aspect thereof a method for conducting an online auction conducts, by an online auction system, the online auction generates a final online auction bid. The online auction system determines whether to generate a counterbid offer responsive to first data relating to a seller and second data relating to a buyer providing the final online auction bid. The online auction system completes the sale of the vehicle responsive to the determination to generate the counterbid offer.

### BRIEF DESCRIPTION OF THE DRAWINGS

For a more complete understanding, reference is now made to the following description taken in conjunction with the accompanying Drawings in which:

FIG. 1 illustrates the operating environment of an auction system including automated counterbidding;

FIG. 2 illustrates a flow diagram of an online auction process;

FIG. 3 illustrates the conduction of a sale with respect to various sales options;

FIG. 4 illustrates a block diagram of an online auction system for conduction an auction between a seller and one or more buyers;

FIG. 5 illustrates various types of information for making auction type decisions;

FIG. 6 illustrates a buyer persona profile;

FIG. 7 illustrates a seller persona profile;

FIG. 8 illustrates a vehicle persona profile;

FIG. 9 illustrates an auction activity profile;

FIG. 10 illustrates a flow diagram of a counterbidding process;

FIG. 11 illustrates a flow diagram of an auction system with auction type and counterbidding modules;

FIG. 12 illustrates an embodiment for storing and controlling rules governing an auction process; and

FIG. 13 illustrates a further embodiment for storing and controlling rules governing an auction process.

### DETAILED DESCRIPTION

Referring now to the drawings, wherein like reference numbers are used herein to designate like elements throughout, the various views and embodiments of a system and method for a counterbidding process in an online auction system are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

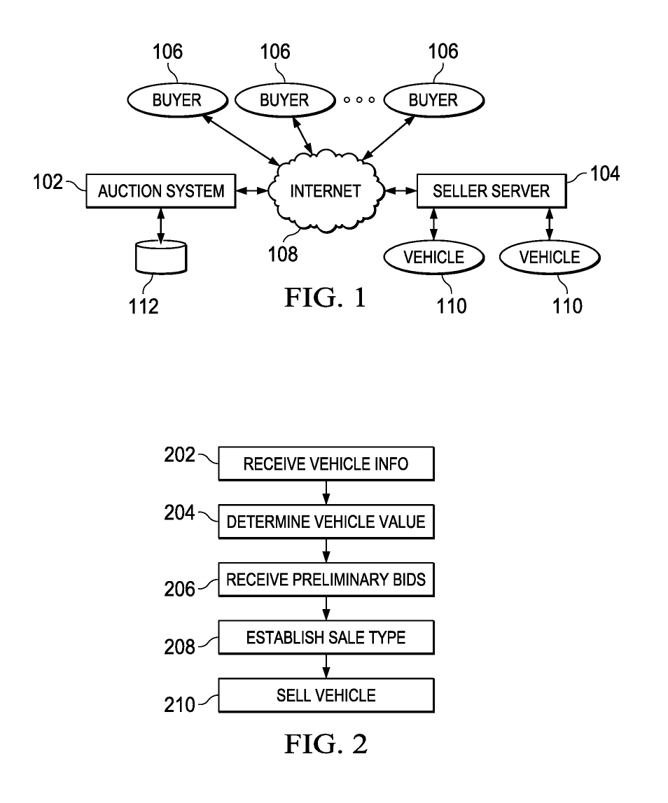

Referring now to the drawings, and more particularly to FIG. 1, there is illustrated the operating environment of the auction system including automated counterbidding according to the present disclosure. The auction system 102, seller server 104 and various buyers 106 are able to communicate with each other via the Internet 108. The auction system 102 acts as a go between the seller server 104 and the buyers 106 and is implemented using an associated processor 103 and memory 105. The seller server 104 contains information concerning one or more vehicles 110 that are to be sold. While the present discussion is made with respect to the sale of vehicles online, any product or service can be sold using the system and process. The information for the vehicle 110 is transmitted from the seller server 104 over the Internet 108 for storage within a database 112 associated with the auction system 102. In addition to information on the vehicle 110, a seller may provide various requirements associated with the sale of the vehicle 110 such as make, model, year, desired price, vehicle condition, title condition, etc. through a user interface 107. Once the information associated with the vehicle 110 has been transmitted and stored in the database 112 of the auction system 102, the information may be accessed by the various buyers 106. The buyers may view the information stored within the database 112 that are associated with the various vehicles 110 provided by a seller to the auction system 102. Responsive to the stored data, the buyers 106 place bids on the vehicles 110 until a highest bidder amongst the buyers 106 is achieved. The sale of the vehicle 110 from the buyer 106 to the seller associated with the seller server 104 is completed either immediately or based upon further communications and negotiations between the buyer 106 and the seller.

Referring now also to FIG. 2, there is illustrated a flow diagram generally describing the online auction process associated with selling a vehicle using the system illustrated with respect to FIG. 1. Vehicle info is received at step 202 by the auction system 102 and stored within the associated vehicle database 112. Using this provided vehicle information, the auction system 102 determines at step 204 a value to associate with the vehicle that is being sold. The auction system 102 next receives preliminary bids at step 206 from the various buyers 106 that may be interested in purchasing the vehicle after reviewing the vehicle information stored within the database 112. Based upon the vehicle being sold, the seller or auction system operator may establish the type of sale for selling the vehicle. Types of sales include a pure sale where whoever wins the online auction receives the vehicle based upon their highest bid, a minimum bid auction wherein a minimum bid must be achieved before the vehicle can be sold to a buyer and a bid to be approved auction wherein the highest bid received by the auction system 102 must be approved by a seller before the sales transaction of the vehicle 110 can be completed. Based upon the sales type that is established by the seller or auction system operator, the vehicle 110 is sold at step 210.

Existing auction systems 102 may have their operations improved by automating additional processes associated with the control of an online auction process. These areas include the initial determination of the type of sale to be carried out by the auction system 102. Currently, a determination of whether a sale of a vehicle comprises a pure sale, minimum bid sale or bid to be approved (BTBA) sale is carried out by a human operator. The human operator analyzes the various conditions associated with a particular sale and makes a judgment call as to the optimal way to sell the vehicle. Additionally, when the BTBA or minimum bid modes of sale of the vehicle are selected, a counterbidding process may occur with respect to the sales. Current counterbidding processes require a seller to look at an offered price and decide whether to make a counter offer to the buyer. The buyer must review this counteroffer and make their own counteroffer or acceptance back to the seller. This process requires a great deal of time and effort on the part of the buyer and seller and requires each of them to be physically involved in the counterbidding process in order to complete the vehicle sale. Thus, a need for improving and streamlining a sale completion in the counterbidding process is needed.

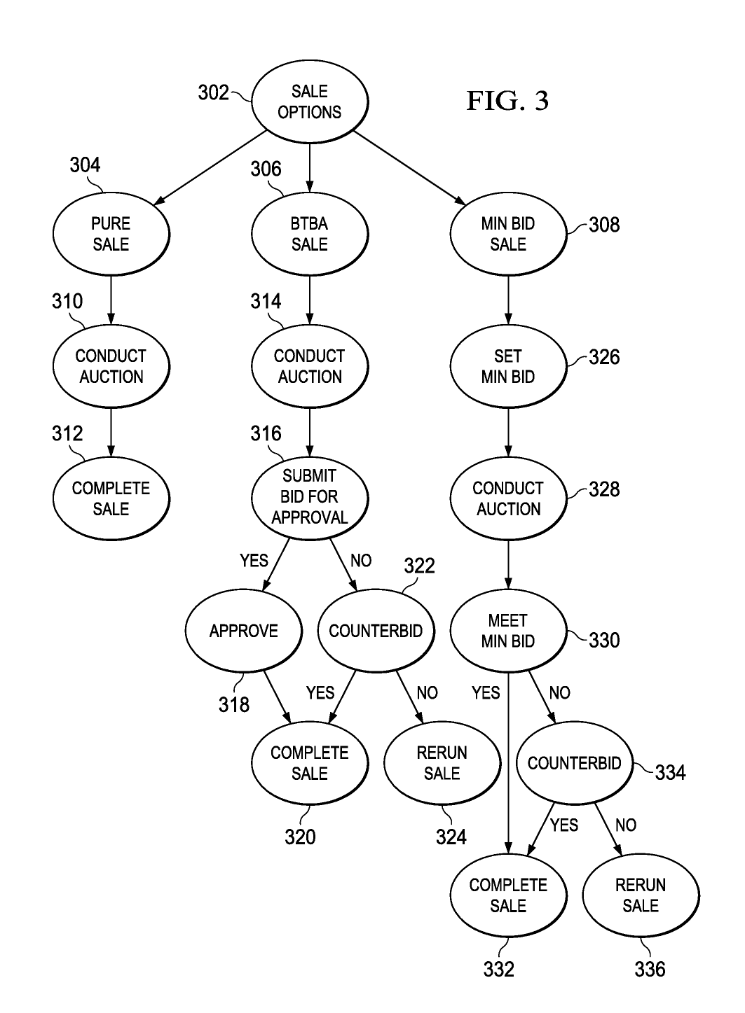

Referring now to FIG. 3, the conduction of a sale with respect to each of the different sales options 302 is illustrated. As discussed hereinabove, the sales options 302 comprise a pure sale 304, a BTBA sale 306 and a minimum bid sale 308. A pure sale 304 occurs when the bids from various buyers are accepted and whichever buyer provides the highest bid wins the vehicle. Thus, in a pure sale 304, the auction is conducted between all of the interested buyers at 310. Once the highest bid is determined from each of the buyers this is automatically accepted by the seller, and the sale is completed at 312.

The BTBA sale 306 involves a process wherein after the auction is completed, the final high bid must be approved by a seller. The seller also has the option of providing a counterbid to the buyer to further increase the bid price for the vehicle. Thus, within the BTBA sale 306, the auction between the seller and one or more buyers is first conducted at 314 until a final high bid price is determined. This final high bid price is submitted for approval at step 316. If the final high bid is approved at step 318, the sale is completed at 320. However, if the bid submitted for approval at 316 is not approved, a counterbid is provided by the seller at 322. If a counterbid final price may not be reached at step 322, the sale may be rerun on the vehicle at step 324. If the counterbid process reaches an acceptable price for the buyer and the seller, the sale is completed at step 320 using the approved price.

A minimum bid sale 308 requires a predetermined minimum bid price to be achieved on the vehicle being sold. The minimum bid is established by the seller at step 326. This minimum bid price is the lowest price the seller is willing to accept for the vehicle in order to complete a sale. The auction is conducted at step 328, and a final high bid price is determined. After completion of the auction, a determination is made at step 330 as to whether the final high auction bid meets or exceeds the predetermined minimum bid value established by the seller at step 326. If the minimum value is met, the sale may be completed at step 332. If the minimum bid value is not achieved, an inquiry is made at step 334 to see if a counterbid offer may be negotiated and accepted between the buyer and the seller. If not, the sale on the vehicle may be rerun at step 336. If a counterbid negotiation can achieve an acceptable sale price for the buyer and the seller at step 334, the sale is completed at step 332.

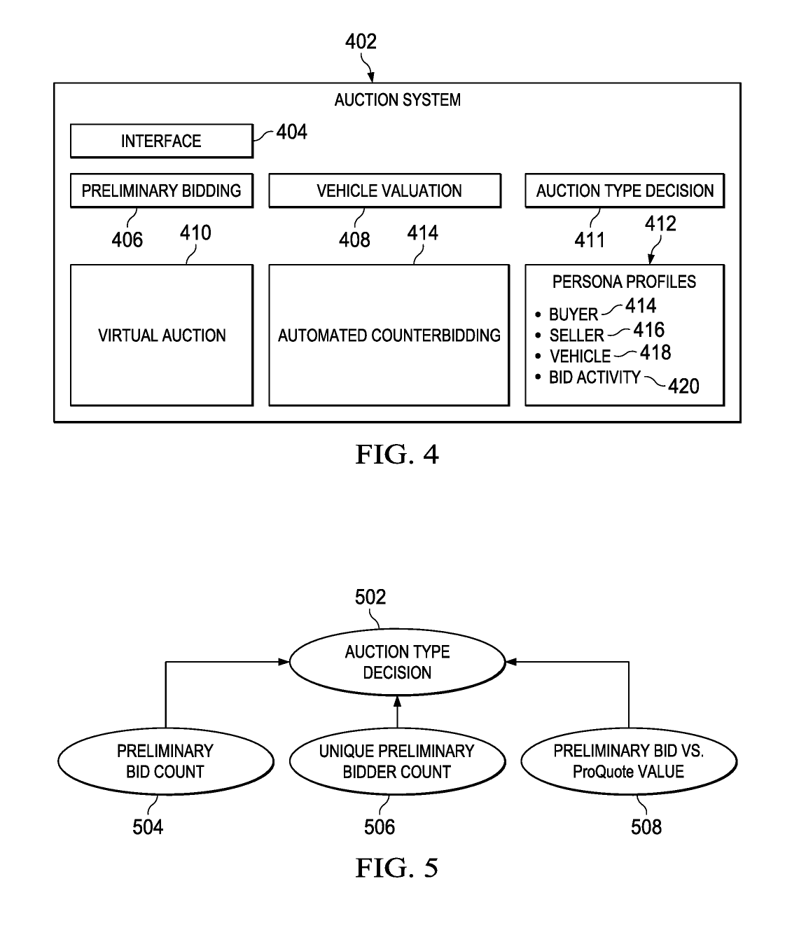

Referring now to FIG. 4, there is illustrated a block diagram of an auction system 402 for conducting an online auction between the seller and one or more buyers. The auction system described herein may for example comprise an auction system such as that described in U.S. Pat. No. 7,315,832 entitled ONLINE BIDDING SYSTEM issued Jan. 1, 2008 which is incorporated herein by reference in its entirety. The auction system 402 includes an interface 404 that enables the auction system to communicate with both buyers and sellers over a network such as the Internet.

The preliminary bidding functionalities 406 enable preliminary bids to be accepted from potential buyers before the auction initially begins. Within the preliminary bidding circuitry 406, online bidders access the IP address/domain name corresponding to a website offering the auction service through the interface 404. Once the bidder accesses the website, they may be required to register for the auction. The registration process may include the bidder providing personal or business information (e.g. name, address, telephone number, etc.), providing a method of payment (e.g. credit card number, bank account number, etc.) in case the bidder prevails with respect to a specific item or items and any other information necessary to implement the online auction, such as a username and password allocation. Once the registration process is completed, the bidder is provided access to items up for bid. It is further envisioned that a registered bidder may be able to access a preliminary auction and a virtual auction by clicking on identified icons or windows displayed on an auction website or website linked to the auction website.

All items offered for bid are assigned to a particular auction date and time and are grouped on a “sale list” with other items assigned to the same date and time. Each item is accompanied by a written description and at least one or more static pictures of an item. Optionally, bidders may view a video type presentation of the item. Alternatively and additionally, bidders may be provided with access to a dynamic picture that may be rotated through 360° allowing a complete view of the item. The specific presentation of the item is based on the preference of the specific website offering an auction. The objective is to provide bidders with a full and complete understanding of the items and its condition so that the bidders may make an educated bid.

During the preliminary bidding portion of the auction, bidders may enter bids on any item contained on the sale list until the preliminary bidding portion ends at a preestablished time. For example, the preliminary bidding portion may last as little as one day, but more often the preliminary bidding portion will last longer (e.g., two weeks) so that bidders can review and enter bids on an item in an open bid format. Preliminary bidding typically ends at some preestablished time prior to the scheduled start time of the virtual auction. A current high bid, along with a minimum required bid increment and lowest possible allowed bid, is displayed for the bidder to review. Thus, during the preliminary bidding portion, bidders are free to input bids on any of the items desired.

During the preliminary bidding portion of the auction, bidders may also input proxy bids. Proxy bids are bids that indicate the bidder is willing, if necessary, to bid up to a maximum amount specified by the bidder. Proxy bids are usually, but not always, a fair amount above the current bit. Therefore, if the current bid is $100, a bidder may input a proxy bid of $250 indicating that the bidder is willing to pay up to $250 to purchase the item. During the pleliminary bidding portion of the auction, the website, or more precisely the website server will, on behalf of the bidder who submitted the proxy bid, submit bids in the minimum bid increment (e.g., $10) in response to each higher bid submitted by another bidder. However, the bidders bid never automatically increases above the $250 proxy bid. In the aforementioned example, the proxy bidders first bid may be automatically input as $110 (i.e., $10 more than the previous high bid). If another bidder and puts $120 bid, the server automatically increases the proxy bidders bid to $130. This procedure continues until a bid exceeds $250, at which time the proxy bidder is eliminated since the bid has exceeded his or her maximum bid amount, or the proxy bidders input bid, which is less than or equal to $250, causes all other bidders to stop bidding. As described in detail below, regardless of the outcome of the preliminary bidding portion of the auction, the item remains available for auction during the virtual auction portion. In other words, the item has not been sold. If in the same example, the preliminary bidding ends at $200, and the proxy bidder is the high bidder, the server will continue to submit proxy bids, not to exceed $250, on behalf of the bidder during the virtual auction.

In addition to the preliminary bidding functionalities 406 discussed hereinabove, vehicle valuation functionalities 408 may be used for determining the value of a vehicle that is being offered for sale. Current techniques of the vehicle valuation functionalities 408 use the ProQuote system for determining the vehicle valuation. The ProQuote system takes information regarding the vehicle make/model/year and vehicle condition and options and determines a value for the vehicle based upon this information.

The virtual auction functionalities 410 control the bidding process between various buyers and sellers to enable a virtual auction of a vehicle or other item that is being offered for sale. The virtual auction functionalities 410 enable the seller to sell the vehicle in a number of different fashions depending upon the desires of the seller. In a first configuration, the seller may set flags such that the auction system 402 will contact the seller in the event of a BTBA type auction, such that the seller can manually approve of a high bid created by the automated auction process. Similarly, in the case of a minimum bid auction, the auction system 402 will contact the seller if a decision is needed when the minimum bid price established by the seller is not achieved during the automated bidding process.

In order to further streamline and improve the operation of the functionalities of the auction system 402, additional processes may be automated rather than requiring manual user selections for the completion of a sale. One example of this arises in the decision on the type of sale to be utilized by the auction system 402. As discussed previously, the automated auction can be carried out using a pure sale, a BTBA sale, or a minimum bid sale. Depending upon various circumstances such as preliminary bidding information, type of vehicle, available buyers, time of year, and a variety of other factors, different ones of these three different types of sales may be most beneficial for auctioning a particular vehicle to activate a highest valve. Current online auction systems rely upon the seller to manually select the particular type of sale to be carried out based upon the experience and instincts of the seller. However, by analyzing various types of data available to the auction system 402, a determination may be made of a best type of sale to be carried out by the auction system based upon current conditions and parameters. These functionalities are implemented within the automated action type decision functionalities 411 of the auction system 402. The automated auction type decision functionality 411 monitors preliminary bidding activity prior to an online auction in order to determine the type of sale to be utilized. Preliminary bidding activity is the best indicator of an item's likelihood to bring its full value.

FIG. 5 illustrates the various types of information that the auction type decision functionalities circuitry 411 may use for making auction type decisions 502. Auction type decisions 502 are made based upon information such as preliminary bid counts 504. Preliminary bid counts 504 comprise the number of bids that were entered by interested buyers during the preliminary bidding process before the actual online auction takes place. Thus, a large number of preliminary bids would indicate a high interest in a vehicle being offered for sale and provide an indication that a pure sale 304 would be an effective manner for selling the vehicle. Alternatively, lower preliminary bid counts would provide a better indication of the use of minimum bids or bid to be approved processes due to low buyer interest. Another factor that is considered by the system in generating recommendations for auction type include the unique preliminary bidder count 506.

The unique preliminary bidder count 506 comprises information on the identity and number of bidders that have entered information in the preliminary bidding process. Knowledge of the number of these bidders and the identity and types of bidders that have entered preliminary bidding information provide another valuable insight into the likelihood that a vehicle will be purchased for a higher auction price or whether a limited number of bidders or high level bidders are interested in the vehicle being offered for sale. Another indication which may be analyzed by the auction type decision functionalities 411 include the preliminary bids versus the ProQuote value data 508. ProQuote value data comprises a vehicle value during a previous nine months, that is associated with its make model and year. If the preliminary bid value indicates bids that are at or above the identified ProQuote value for the vehicle, then sales using a pure sale process 304 are selected. However, should the preliminary bids fall substantially below the ProQuote value, then sales using BTBA sales 306 or minimum bid value sales 308 would be selected by the system.

The auction type decision module 411 within the auction system 402 analyzes each of the preliminary bid count 504, unique preliminary bidder count 506, preliminary bid versus ProQuote value 508 and any other factors relating to the potential final auction value of a vehicle that is being offered for sale by the online auction system 402. This data is analyzed by the system and an automated decision is made of whether to sell the vehicle using a pure sale 304, BTBA sale 306 or minimum bid sale 308. The auction type decision module 411 will configure the auction system 402 to carry out the sale in accordance with the identified optimal sales process.

Referring now back to FIG. 4, the automated counterbidding functionalities 414 are used in running BTBA sales 306 and minimum bid sales 308. In standard BTBA sales 306 and minimum bid sales 308, a point comes where the seller must determine whether to make a counteroffer to a potential buyer. This occurs either in the acceptance process of a BTBA sale 306 or during acceptance of a lower than minimum bid during a minimum bid sale 308. The automated counterbidding functionalities circuitry 414 will consider various information available within a persona profile database 413 in order to generate or determined not to generate a counterbid offer without manual inputs from the buyer or seller. This enables the sales process to proceed more quickly without waiting for further manual inputs or acceptances from the individual buyers and sellers. The automated counterbidding functionalities 414 provide an algorithmic and logic driven automatic decision tool. It enables counterbidding operations to be formed automatically without user input and eliminates the need for the seller to set minimum bids prior to an auction. The automatic counterbidding functionalities 414 greatly improve the speed and responsiveness for buyers in the counterbidding process. It also maximizes returns for sellers while creating a fair and friction free process for the buyers.

The persona profiles 412 contain a variety of information that enables the automated counterbidding functionalities 414 to determine how the seller would react in a particular buying situation based upon previously monitored activity or predetermined buying factors. The persona profiles 412 include but are not limited to buyer persona profiles 414, seller persona profiles 416, vehicle persona profiles 418 and bid activity persona profiles 420. Each of these profiles 412 includes information relevant to the generation of a counterbid depending upon who is involved in a sale and what is being purchased.

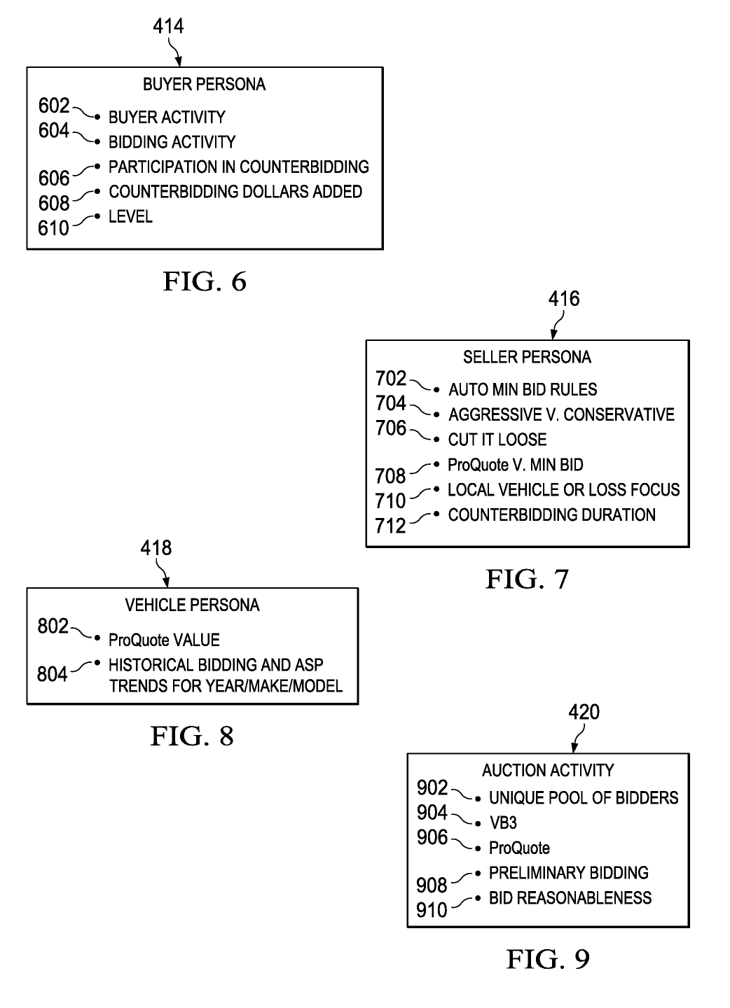

Referring now also to FIG. 6, there is illustrated the buyer persona profile 414. The buyer persona profile 414 contains various relevant information concerning the person that is bidding to buy a particular vehicle. This information comprises but is not limited to buyer activity 602, bidding activity 604, participation in counterbidding 606, counterbidding dollars added 608 and the persona level 610. The buyer activity 602 comprises information regarding previous activities of the buyer, business that the buyer is engaged in, and information on the buyer identity. The bidding activity 604 comprises information concerning the buyers previous bids and actions associated with those bids. Information such as the number of bids that a buyer has made, the amounts bid during those options, the number of auctions that have been won by the buyer, the number of auctions that a buyer has been involved in, etc. Participation in counterbidding 606 would comprise an indication of whether or not a particular buyer usually participates in a counterbidding situation. Some buyers may reject any counterbidding offers out of hand. Other buyers may actively participate in counterbidding in order to purchase an item in which they are interested. In either case, knowledge of the buyers likelihood to participate in counterbidding can affect whether to provide a counterbid offer and suggest a potential amount.

Counterbidding dollars added 608 provides an indication of the amount a bid value has been raised by a buyer in response to a previous counterbidding process. For example, one buyer may be willing to increase their final bid offers by significant amounts in order to obtain a vehicle during a counterbidding process. Other buyers may have shown a propensity to only increase bids by small amounts. Finally, all of this information may be used to establish a persona level 610 for an individual buyer. Buyer personas may be rated as bottom, low, medium and high persona levels. A bottom persona level would provide an indication that a particular buyer virtually never participates in a counterbidding process. Similarly, a high persona level would provide an indication that a buyer is a counterbidding “player” and actively counterbids. The low and medium persona levels would of course fall somewhere in the range between the bottom and high levels. The particular metrics associated with the bottom, low, medium and high persona levels may be established by the user in establishing interest in levels associated with the automated counterbidding functionalities 414.

Referring now to FIG. 7, there is illustrated the seller persona profile 416. The seller persona profile 416 includes a number of characteristics related to the entity selling the vehicle that may be used in determining counterbidding options. These factors include automated minimum bid rule 702, aggressive versus conservative seller 704, cut it loose determination 706, ProQuote value versus minimum bid value 708 local vehicle or lost focus 710 or counterbidding duration 712. Each of these factors contributes to the determining whether to counterbid and the amount of the counterbid by the seller. The automated minimum bid rules 702 define the minimum bids that a seller is willing to take for a vehicle and whether or not the seller is willing to operate under minimum bid rules. The aggressive versus conservative rule 704 indicates whether the seller is an aggressive counterbidder or a conservative counterbidder. Aggressive counterbidder indications would call for counterbidding more often rather than accepting a final auction bid value and asking for more money in the counterbid offer. Alternatively, more conservative indications would lead to less use of the counterbid process and smaller increases in the counterbid offers over final auction bid value.

Cut it loose indications 708 include a listing of considerations that when a final auction bid value is within an established percentage of the predetermined vehicle value and the persona of the buyer indicates that they are a low or bottom bidder that are not likely to engage in a counterbidding process, this causes the automated counterbidding functionalities 414 to accept the final auction bid value rather than attempting to initiate a counterbidding process. The ProQuote value versus minimum bid value 708 establishes that when the minimum bid values are within a certain range of the predetermined vehicle value that minimum bid offers should be accepted. The local vehicle or loss focus 710 indicates the location and condition of the vehicle. Vehicles that are located locally may sell for lower values since shipping cost are not an issue. Additionally if the vehicle condition is rather poor, the seller may be willing to take a lower bid in order to get rid of the vehicle, or alternatively, vehicles in good condition could go for higher values since refurbishment and repairs were not needed. Counterbidding duration 712 relates to time period that a buyer and seller have for responding to a counterbid.

Referring now to FIG. 8, there is illustrated the vehicle persona profile 418. The vehicle persona profile 418 contains information related to particular vehicles that are being offered for sale. This information includes the vehicle value 802 and historical bidding and ASP trends for year/make/model 804. The vehicle value 802 may comprise, for example, a ProQuote value or other type of vehicle valuation system. The ProQuote value provides statistics relating to the vehicle value of similar make, model and year for the last nine months. The historical bidding and ASP trends 804 provide particularized information regarding sales of similar vehicles of the same year/make/model. This type of information will assist in determining potential sales values for a vehicle being sold.

Finally, FIG. 9 illustrates the auction activity profile 420 containing various types of information about particular auctions. The unique pool of bidders 902 contains information about the particular bidders involved in the current auction. The VB3 information 904 contains data concerning the preliminary bidding information. The ProQuote value 906 contains information of the vehicle value for the current vehicle being sold. Preliminary bidding information 908 contains data regarding the preliminary bidding of individuals with respect to a particular product. This preliminary bidding information 908 may be used in determining the counterbids associated with a particular type of sale. Bid reasonableness 910 contains metrics regarding what reasonable bids would be for a particular vehicle and may be used for calculating potential counteroffers.

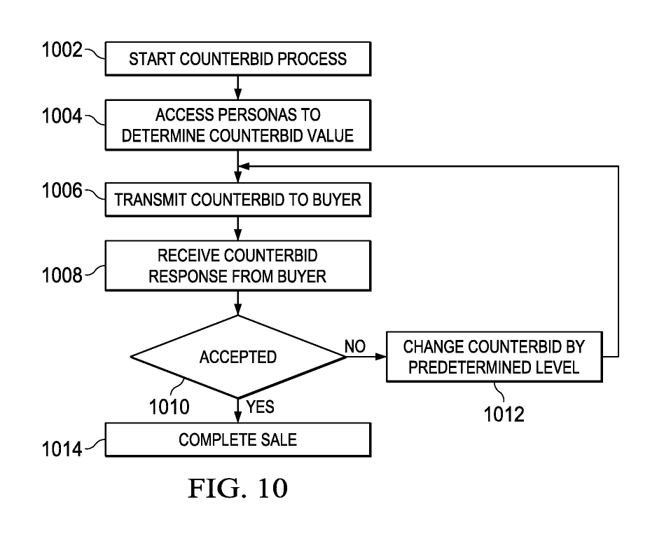

If the automated counterbidding functionalities 414 determine that a counterbidding process is practical based on the associated data within the persona profiles 412, the counterbidding process such as that illustrated in the flowchart of FIG. 10 may be implemented. Once the automated counterbidding functionalities 414 determined that a counterbidding process is necessary, the counterbidding process is first initiated at step 1002. The various personas associated with the buyer, seller, vehicle being sold and current auction activity are accessed at step 1004 to determine an appropriate counterbid value. The generated counterbid is transmitted to the buyer at step 1006. A received counterbid response from the buyer at step 1008 enables inquiry step 1010 to determine whether the counterbid response should be accepted or rejected by the seller. If not accepted, the counterbid value of the seller is lowered by predetermined amount at step 1012 and this new counterbid value is transmitted to the buyer at step 1006. If the counterbid of the seller has been accepted by the buyer, the sale is completed at step 1014.

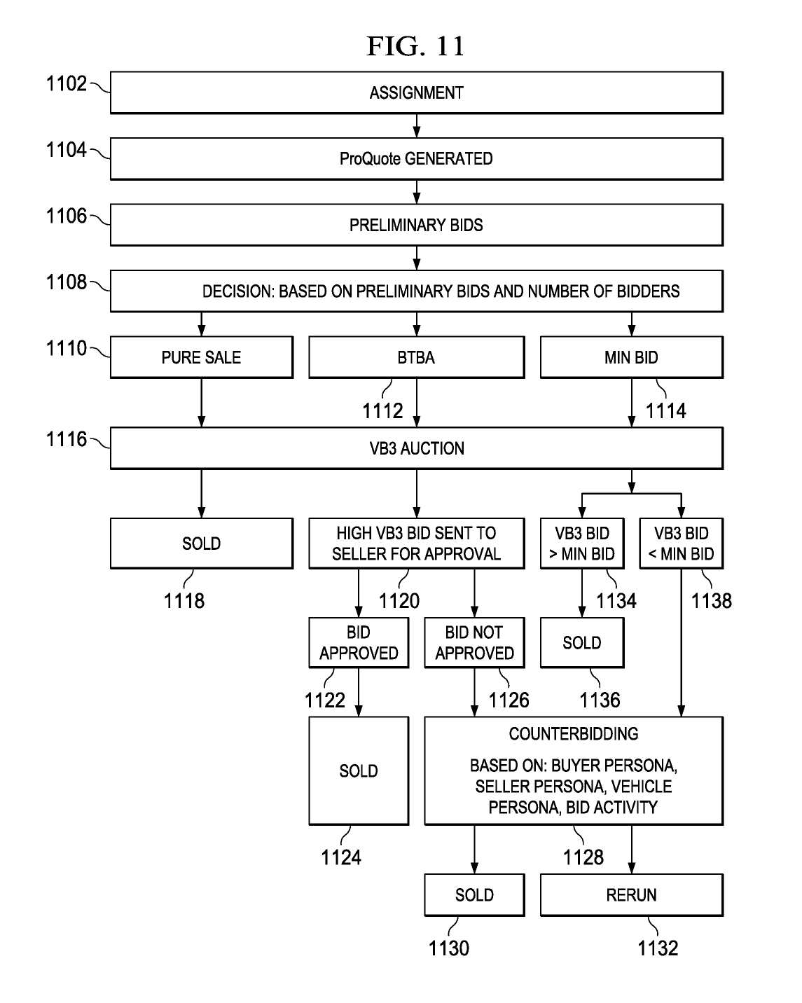

Referring now to FIG. 11, there is provided a flow diagram describing the operation of an online auction system that includes auction type decision functionality modules 412 and automated counterbidding functionality modules 414 for operating within the auction system 402. Initially, a vehicle to be sold is assigned to the online auction system 402 and all of the appropriate information relating to the vehicle entered in to the online auction system. Using the provided vehicle information, a vehicle value is generated at step 1104 using for example the ProQuote system. Potential buyers may log into the system and generate preliminary bids at step 1106 based upon their interest within the registered vehicle. Using the received preliminary bids and the number of bidders the auction type decision functionality block 412 of the auction system 402 makes a determination of the particular type of sale to be carried out. The decision may select either a pure sale 1110, a BTBA sale 1112 or a minimum bid sale 1114. The online auction system 402 (in one example a VB3 auction) will then conduct the online auction at step 1116 using the selected sale type.

If the pure sale 110 has been selected, the online auction system conducts the auction at step 1116 and the vehicle is sold at step 1118 to a highest auction bidder. If the BTBA sale 1112 branch has been selected, the online auction is conducted at step 1116 and the high bid is sent to a seller for approval at step 1120. The automated counterbidding functionality module 414 analyzes the high bid and a determination action may be made to approve the bid at step 1122, and the vehicle is sold at step 1124. If the automated counterbidding functionalities 414 do not approve the bid at step 1120, the automated counter billing process is carried out at step 1128 based upon the buyer persona, the seller persona, the vehicle persona and the bid activity as described herein above. The counterbidding process at step 1128 will either sell the vehicle at step 1130 if a counterbid offer is accepted or rerun the sale at step 1132 if no counterbid can be accepted.

When minimum bid sale 1114 is selected, the online auction system 102 conducts the online auction with a minimum bid at step 1116. If the final bid is greater than the minimum bid at step 1134, the vehicle is sold for the final bid price at step 1136. If the final bid is less than the minimum bid at step 1138, the control passes to the automated counterbidding functionality 414 and counterbid offers are generated as discussed hereinabove at step 1128 based upon buyer personas, seller personas, vehicle persona and bid activity. If a counterbid offer is accepted, the vehicle is sold at step 1130. If no counterbid offer is accepted, the sale may be rerun at step 1132.

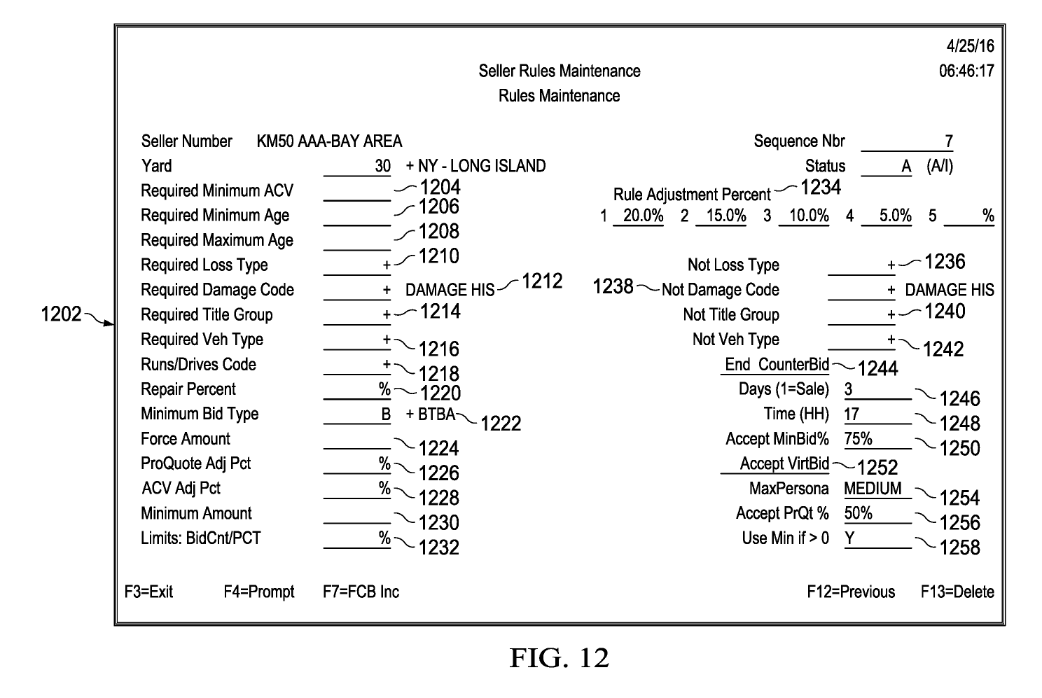

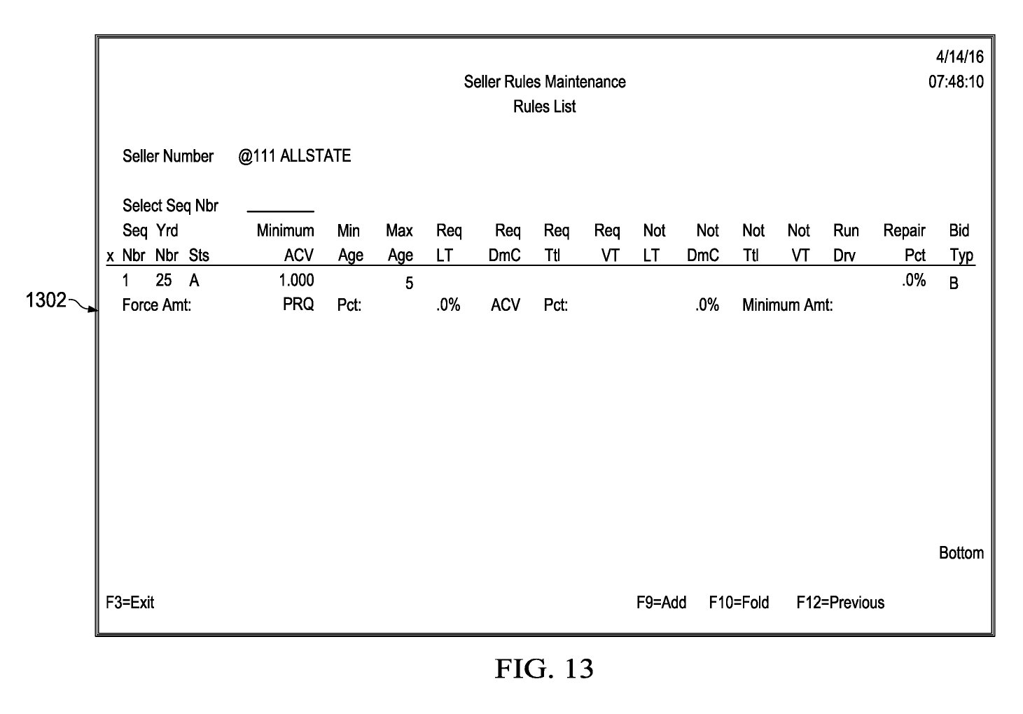

The operations of the auction sale type selection functionality 411 and the automated counterbidding processes 414 are established by the seller and/or the system operator according to various predetermined values and flags that are generated by the seller. Referring now to FIG. 12, there is illustrated an interface of the auction system called the rules maintenance page 1202 that includes various fields and flags that may be set by the seller in order to control the manner in which the auction type selection may be made and the counterbidding process may be controlled. The illustrations with respect to FIGS. 12 and 13 illustrate one embodiment for storing and controlling the rules governing the auction process. This embodiment uses a AS400(CAS) System. However, other types of rules storage databases, systems or configurations, for example a Drools Workbench, may also be used for storing the information. Required minimum ACV field 1204 may establish the minimum ACV value for the vehicle that will be allowed by the counterbidding system. The ACV value comprises the actual cash value of the vehicle. The required minimum age field 1206 enables the user to establish the minimum age of the vehicle being sold, and the maximum age field 1208 enables establishment of a maximum vehicle age. The required loss type field 1210 identifies at least one loss type associated with the vehicle. The damage code field 1210 includes codes identifying types of damage to the vehicle.

The required title group field 1214 indicates if clear title is available for the vehicle. The vehicle type field 1216 indicates the type of vehicle being sold. The run/drives code field 1218 indicates whether the vehicle is running and drives. The repair percent field 1220 indicates the amount of the vehicle requiring repair. The minimum bid type field 1222 enables a flag to be set to establish which type of minimum bid type will be used for a sale, examples include ACV based, BTBA, ProQuote, ect. The force amount field 1224 indicates a fixed minimum bid value that is only used if the minimum bid type is selected. The ProQuote adjusted percentage field 1226 indicates the percent adjustment of a ProQuote value if a ProQuote value is chosen as the Minimum Bid Type. The ACV adjusted percentage 1228 indicates the percentage adjustments of an ACV value if ACV is chosen in the Minimum Bid Type. The minimum amount field 1230 establishes the minimum amount that will be accepted for the vehicle. The limits bid count/percentage fields 1232 represent the count of preliminary bids and their percent distance from the ProQuote amount that is used to determine if the vehicle will be sold as a pure sale or be sent to the counterbidding process. The rule adjustment percentage of fields 1234 provide the amount that counterbid offers can be decreased in successive counterbid offers. Thus in the examples illustrated herein, the first counterbid offer will increase over the final auction bid by 20%, the next counterbid offer would increase by 15% over the final auction bid if the first counter offer one not accepted, the third counterbid would be 10% over the final auction bid the fourth counteroffer 5% over the auction bid in the fifth counterbid equal to the auction bid.

The not loss type field 1236 specifically excludes a certain loss type from a sale. The not damage code field 1238 specifically excludes a certain damage type from a sale. The not title group field 1240 specifically excludes a certain title group from the sale and the not vehicle type field 1242 enable entry of information excludes a certain vehicle type from the sale.

The end counterbid section 1244 includes a days field 1246 for entering a number of days that the counterbidding process is allowed to go on for. A time field 1248 for entering a duration in hours that the counterbidding process is allowed to go on for and an except minimum bid percentage field 1250 for entering a percentage value indicating that if the bid is within this percentage of the minimum bid that the bid is to be accepted.

The accept virtual bid section 1252 includes the maximum persona field 1254 for entering the persona of the seller as bottom, low, medium or high level as discussed hereinabove. The accept ProQuote percentage field 1256 for entering a percentage indicating that if that percentage of the ProQuote value is obtained by the final auction bid, the bid is automatically accepted. Field 1258 indicates whether minimum bid value is used if the final bid value is greater than zero.

Referring now to FIG. 13, there is illustrated the rules list screen 1302. The rules list screen 1302 provides a summary of the sequence rules for specific sellers. The rules defined within the rules list screen can be changed using the field and entries discussed above in the rules maintenance page 1202 discussed above with respect to FIG. 12. If a seller has not established any seller specific values using the interface discussed with respect to the rules maintenance page 1202, the fields and flags with be set to the default values.

It will be appreciated by those skilled in the art having the benefit of this disclosure that this system and method for counterbidding process in an online auction system provides an improved counterbidding process that does not require real-time manual input in order to complete an online auction sale. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A method for conducting an online auction comprising:
accessing, by an online auction system, generated preliminary bidding data relating to a vehicle for sale from a plurality of potential buyers;
analyzing, by the online auction system, the generated preliminary bidding data to select a first type of online auction using counterbidding or a second type of online auction not using counterbidding most likely to generate a highest final bid price;
conducting, by the online auction system, the online auction using the online auction system responsive to the selected first type of online auction or the selected second type of online auction to generate a final online auction bid;
if the second type of online auction was selected, completing a sale of the vehicle using the final online auction bid;
if the first type of online auction was selected, determining, by the online auction system, whether to generate a counterbid offer responsive to first data relating to a seller and second data relating to a buyer providing the final online auction bid; and
completing the sale of the vehicle responsive to the determination to generate the counterbid offer.

2. The method of claim 1, wherein the step of determining whether to generate the counterbid offer further comprises generating a first counterbid offer to the buyer responsive to the first data relating to the seller and the second data relating to the buyer.

3. The method of claim 2 further comprising the step of generating a second counterbid offer to the buyer responsive to a rejection of the first counterbid offer by the buyer, the second counterbid offer reduced from the first counterbid offer by a predetermined amount.

4. The method of claim 1, wherein the step of determining whether to generate the counterbid offer further comprises accepting the final online auction bid as a final sales price.

5. The method of claim 1, wherein the step of analyzing further comprises analyzing the generated preliminary bidding data to select one of a pure auction sale that does not use counterbidding, a bid to be approved sale that uses counterbidding and a minimum bid sale that uses counterbidding.

6. The method of claim 1, wherein the step to determine whether to generate the counterbid offer is further responsive to third data relating to the vehicle and to fourth data relating to bid activity for the vehicle.

7. The method of claim 1, wherein the generated preliminary bidding data further comprises at least one of a preliminary bid count, preliminary bidder count, preliminary bid values and vehicle value.

8. A method for conducting an online auction comprising:
conducting, by an online auction system, the online auction using the online auction system to generate a final online auction bid;
determining, by the online auction system, whether to generate a counterbid offer responsive to first data relating to a seller and second data relating to a buyer providing the final online auction bid; and
completing the sale of the vehicle responsive to the determination to generate the counterbid offer.

9. The method of claim 8, wherein the step of determining whether to generate the counterbid offer further comprises generating a first counterbid offer to the buyer responsive to the first data relating to the seller and the second data relating to the buyer.

10. The method of claim 9 further comprising the step of generating a second counterbid offer to the buyer responsive to a rejection of the first counterbid offer by the buyer, the second counterbid offer reduced from the first counterbid offer by a predetermined amount.

11. The method of claim 8, wherein the step of determining whether to generate the counterbid offer further comprises accepting the final online auction bid as a final sales price.

12. The method of claim 8, wherein the step to determine whether to generate the counterbid offer is further responsive to third data relating to the vehicle and to fourth data relating to bid activity for the vehicle.

13. The method of claim 8 further including the steps of:
accessing, by an online auction system, generated preliminary bidding data relating to a vehicle for sale from a plurality of potential buyers; and
analyzing, by the online auction system, the generated preliminary bidding data to select a first type of online auction using counterbidding or a second type of online auction not using counterbidding most likely to generate a highest final bid price.

14. The method of claim 13, wherein the generated preliminary bidding data further comprises at least one of a preliminary bid count, preliminary bidder count, preliminary bid values and vehicle value.

15. The method of claim 13, wherein the step of analyzing further comprises analyzing the generated preliminary bidding data to select one of a pure auction sale that does not use counterbidding, a bid to be approved sale that uses counterbidding and a minimum bid sale that uses counterbidding.

16. An online auction system for conducting on online auction, comprising:
a user interface enabling a seller to establish requirements for the online auction;
a processor coupled to the user interface;
a database including a plurality of personal profiles;
a memory coupled to the processor and configured to store a plurality of instructions executable by the processor, the instructions including instruction for:
accessing, by the online auction system, generated preliminary bidding data relating to a vehicle for sale from a plurality of potential buyers;
analyzing, by the online auction system, the generated preliminary bidding data to select a first type of online auction using counterbidding or a second type of online auction not using counterbidding most likely to generate a highest final bid price;
conducting, by the online auction system, the online auction using the online auction system responsive to the selected first type of online auction or the selected second type of online auction to generate a final online auction bid;
if the second type of online auction was selected, completing a sale of the vehicle using the final online auction bid;
if the first type of online auction was selected, determining, by the online auction system, whether to generate a counterbid offer responsive to first data of a seller personal profile relating to a seller and second data of a buyer personal profile relating to a buyer providing the final online auction bid stored within the personal profile of the database; and
completing the sale of the vehicle responsive to the determination to generate the counterbid offer.

17. The online auction system of claim 16, wherein the instructions further include instructions for determining whether to generate the counterbid offer further comprises generating a first counterbid offer to the buyer responsive to the first data relating to the seller and the second data relating to the buyer.

18. The online auction system of claim 17 further including instructions for generating a second counterbid offer to the buyer responsive to a rejection of the first counterbid offer by the buyer, the second counterbid offer reduced from the first counterbid offer by a predetermined amount.

19. The online auction system of claim 16, wherein the instructions further include instructions for determining whether to generate the counterbid offer further comprises accepting the final online auction bid as a final sales price.

20. The online auction system of claim 16, wherein the instructions further include instructions for analyzing further comprises analyzing the generated preliminary bidding data to select one of a pure auction sale that does not use counterbidding, a bid to be approved sale that uses counterbidding and a minimum bid sale that uses counterbidding.

21. The online auction system of claim 16, wherein the instructions for determining whether to generate the counterbid offer is further responsive to third data of a vehicle personal profile relating to the vehicle and to fourth data relating of a bid activity personal profile to bid activity for the vehicle stored within the personal profile of the database.

22. The online auction system of claim 16, wherein the generated preliminary bidding data further comprises at least one of a preliminary bid count, preliminary bidder count, preliminary bid values and vehicle value.
